(19) United States
(12) Patent Application Publication
(10) Pub. No.: US 2022/0413334 A1
(43) Pub. Date: Dec. 29, 2022

(54) SMART WINDOW DEVICE WITH INTEGRATED TEMPERATURE CONTROL AND RELATED METHODS

(71) Applicant: Corning Incorporated, Corning, NY (US)

(72) Inventor: Sean Matthew Garner, Elmira, NY (US)

(21) Appl. No.: 17/777,476

(22) PCT Filed: Nov. 19, 2020
(86) PCT No.: PCT/US2020/061156

§ 371 Date: May 17, 2022

Related U.S. Application Data
(60) Provisional application No. 62/939,235, filed on Nov. 22, 2019.

(51) Int. Cl. G02F 1/1333; E06B 9/24; G02F 1/137; G02F 1/166; G02F 1/1676; H05B 3/84

(52) U.S. Cl. CPC G02F 1/133382; E06B 9/24; G02F 1/137; G02F 1/166; G02F 1/1676; H05B 3/84; E06B 2009/2464; G02F 2202/36; G02F 2202/14; G02F 2001/1678

(57) ABSTRACT

Methods relating to and an apparatus including: a smart device and an integrated heating module are provided. The apparatus includes: a smart device having an electrically switchable material, a first transparent layer and a second transparent layer, wherein the electrically switchable material is retained between a first transparent layer and a second transparent layer; and an integrated heating module configured between the electrically switchable material and one of: the first transparent layer and the second transparent layer, wherein the integrated heating module is configured to provide resistant heating along at least a portion of the electrically switchable material.

### CROSS REFERENCE TO RELATED APPLICATIONS

This application claims the benefit of priority under 35 U.S.C. § of U.S. Provisional Application No. 62/939,235 filed Nov. 22, 2019, the content of which is incorporated herein by reference in its entirety.

### FIELD OF THE INVENTION

Generally, the present disclosure relates to various embodiments of a smart window assembly having an integrated thermal control module (e.g. heating device). More specifically, the present disclosure relates to various embodiments that are configured to provide tailored heating to smart window assemblies, such that the resulting smart window is capable of actuating in varying conditions (e.g. low temperature and/or temperature gradients across the smart window assembly). Thus, a smart window with thermal control module is configured to switch with optical uniformity (e.g. improved optical switching and resulting transmission during operation).

### BACKGROUND

There are challenges to commercializing large switchable applications for large dimension applications, including among others, architectural and automotive applications. Large-dimensioned windows weather extreme temperatures, temperature gradients across their surface area and/or cross-sectional thickness, temperature fluctuations in short time periods, and/or combinations thereof, which make operation, including optical switching, challenging.

### SUMMARY OF THE INVENTION

Depending on the external environment (weather, external temperature, sunlight exposure), the temperature of the smart window (e.g. smart device configured for a plurality of modes, including transparent mode) may fluctuate or have a thermal gradient across its area. This thermal gradient across the smart window can result in non-uniform switching and, therefore, non-uniform optical transmission across the window that can easily be noticed visually. Also, the temperature of the smart device can impact overall rate of transmission (e.g. slower at colder temperatures rather than faster at warmer temperatures). Finally, in instances of extreme cold, the resulting components of the electrically switchable material can dissociate and/or separate, so maintaining the smart window at temperatures to maintain viability (continued use of the smart window) and maintain operation (e.g. efficient switching/visual observation of uniform switching) is desired.

Smart devices include switchable glass or switchable glazing that are configured with alterable light transmission properties when voltage is applied (e.g. changing transmission properties from transparent to translucent). Various non-limiting examples of smart window or smart devices include: liquid crystal window and an electrochromic window, among others.

With an integrated heating module in the smart window, the various embodiments disclosed herein are specifically tailored to locally control switching characteristics (e.g. via heating) to counteract changing environmental conditions including external temperature variations and sunlight exposure. In some embodiments, through one or more of the various methods, temperature is uniformly controlled across a large smart device (e.g. smart window surface area at least 10″×10″), resulting in a uniform optical transmission (e.g. from a first transmittance to a second transmittance). One or more apparatuses of the present disclosure are configured with an improved switching (e.g. uniform, fast switching), an improved dynamic range (e.g. high dynamic range), and prevention of freezing/dissociation of the electrically switchable material formulations and/or components.

In one aspect, an apparatus is provided, comprising: a smart device comprising: a first layer (e.g. glass layer); a second layer (e.g. glass layer), an electrically switchable material configured between the first layer and the second layer, wherein the electrically switchable material is configured to provide a transparent mode and a non-transparent mode (e.g. opacity, shading, translucent), a pair of electrodes (e.g. including an anode and a cathode), wherein each of the electrodes is configured in electrical communication with the electrically switchable material; and a power source configured in electrical communication with the electrodes, further wherein the power source is configured to provide: (1) a switching mode current to the electrically switchable material; and (2) a heating mode current via at least one electrode.

In some embodiments, the electrode (of the smart device) is configured as an ohmic heater. As an ohmic heater, the electrode conducts heat through adjacent smart window components, including the electrically switchable material, first layer, and/or second layer.

In another aspect, an apparatus is provided, comprising: a smart device comprising an electrically switchable material, a first transparent layer and a second transparent layer, wherein the electrically switchable material is retained between a first transparent layer and a second transparent layer; and an integrated heating module configured between the electrically switchable material and one of: the first transparent layer and the second transparent layer, wherein the integrated heating module is configured to provide resistant heating along at least a portion of the electrically switchable material.

In some embodiments, the smart device comprises a smart window.

In some embodiments, the smart window is greater than 10″ (in a length or width (e.g. 10″×10″).

In some embodiments, the smart window is greater than 0.5 m in a length or width (e.g. 0.5 m×0.5 m). In some embodiments, the smart window is greater than 0.5 m in a length or width (e.g. 0.5 m×0.5 m).

In some embodiments, the smart window is greater than lm in a length or width (e.g. 1 m×0.5 m, 1 m×1 m).

In some embodiments, the smart window is greater than 2 m in a length or width (e.g. 2 m×0.5 m; 2 m×1 m; 2 m 1.5 m; or 2 m×2 m).

In some embodiments, the smart window has a surface area of at least 0.5 meters (when measured in an x or y direction). In some embodiments, the smart window has a surface area of at least 1 meter (when measured in an x or y direction). In some embodiments, the smart window has a surface area of at least 1.5 meter (when measured in an x or y direction). In some embodiments, the smart window has a surface area of at least 2 meters (when measured in an x or y direction). In some embodiments, the smart window has a surface area of greater than 2 meters.

In some embodiments, the smart window is selected from the group consisting of: a liquid crystal window; a photochromic window, a micro-blinds window, and suspended particles window.

In some embodiments, the smart window comprises a liquid crystal, electrically switchable material comprises at least one liquid crystal.

In some embodiments, the smart window is a single pixel cell liquid crystal window.

In some embodiments, the liquid crystal device includes polyimide alignment layers and liquid crystal layer, with the liquid crystal composition including various components (e.g. liquid crystal molecule(s), dye(s), additive(s), and/or surfactant(s), among other items).

In some embodiments, the smart window comprises a photochromic window, the electrically switchable material comprises a nano-crystalline film.

In some embodiments, the smart window comprises a micro-blinds window, the electrically switchable material comprises a plurality of conductive metal oxide members.

In some embodiments, the smart window comprises a suspended particle window, the electrically switchable material comprises a plurality of rod-shaped, electrically alignable particles. members.

In some embodiments, the heating module comprises: an electrically insulating sheet (e.g. dielectric sheet) configured to promote electrical separation from the electrically switchable material and the heating module (e.g. and configured to allow heat conduction/radiation); and a power supply configured to provide current to the heating module, wherein the power supply is configured electrically isolated from the electrically switchable material.

In some embodiments, the heating module comprises a resistance layer.

In some embodiments, the resistance layer is a transparent conductive layer.

In some embodiments, the smart window the resistance layer is configured as a sheet, a coating, a film, and/or combinations thereof.

In some embodiments, the heating module comprises a resistance element.

In some embodiments, the resistance element is selected from: a transparent conductive layer, a semi-transparent conductive layer, a non-transparent conductive layer, and combinations thereof.

In some embodiments, the resistance element is configured with a tailored pattern.

In some embodiments, the tailored pattern is selected from the group consisting of: a grid, a ribbon, a wire, a mesh, a geometric shape, a plurality of concentric shapes, and/or combinations thereof.

In some embodiments, the heating module comprises: a resistance layer and a resistance element.

In some embodiments, the smart window is selected from the group consisting of: a curtain wall, a sky light, an architectural window, an automotive window, a train window, an aerospace window, a nautical window, or combinations thereof.

In some embodiments, the heating module is configured to radiantly heat one or more window components, including at least the electrically switchable material, so as to provide temperature uniformity.

In some embodiments, the electrodes of the smart device are configured from a transparent conducting material.

In some embodiments, the insulating layer (e.g. dielectric sheet) is configured from a non-conductive, optically transparent material.

In some embodiments, the insulating layer is a dielectric member.

In some embodiments, the insulating layer comprises SiO2.

In some embodiments, the heating member is deposited or coated onto the electrically switchable material.

In some embodiments, the heating member is configured to provide resistive heating at an amount of at least 100 ohms/sq meter to the electrically switchable material.

In some embodiments, the transparent conducting material is selected from the group consisting of: conductive oxides, ITO, IZO, AZO, and combinations thereof.

In some embodiments, the resistance element is configured from a metallic wire having a size of not greater than 10 micrometers wide.

In some embodiments, the resistance element comprises a metal.

In some embodiments, the resistance element comprises aluminum-containing materials, silver-containing materials, copper-containing materials, and combinations thereof.

In some embodiments, the heating module (e.g. at least one resistance element or resistance layer) is configured across a surface of a smart device. In some embodiments, the heating module is configured between (a) one of a first layer and a second layer and (b) the insulating layer (e.g. dielectric material).

In some embodiments, a plurality of heating modules are configured to corresponding portions of a smart device, such that a plurality of zones are defined (e.g. zone₁; zone₂, zoneₙ), such that the zones are controlled individually and/or in combination, based on the sensor data.

In some embodiments, the heating module is operated to actively maintain uniform optical transmission across the window. For example, the heating module is operated via continuous feedback and on-going control (e.g. electrical power) is required.

In some embodiments, the heating module is operated during window transition times, to provide maximum transmission rate from a first transmission state to a second transmission state. For example, the heating module is configured with an on mode and an off mode, such that the heating module is in off mode (e.g. electrical power off) when the smart window is not being operated (switched). Then, in this embodiment, the heating module is configurable to go into on mode and/or active control mode with on-going power use (e.g. smart window switching), such that the heating module can maximize optical transmission uniformity along with the rate of optical transmission, during transition periods (e.g. switching of the smart device).

In some embodiments, the resistance layer is deposited adjacent to the smart device, between the insulating layer and the first layer or second layer. In some embodiments, the resistance layer is deposited, then etched to make a pattern (e.g. etching can include wet etch with an acid, plasma etc, or selectively ablate). In some embodiments, the resistance layer or resistance element can be printed onto the insulating layer or onto an inner surface of the first layer or second layer.

In another aspect, a method is provided, comprising: sensing a plurality of temperatures at a plurality of locations along a smart window; detecting a temperature gradient above a predetermined threshold; heating at least a portion of the smart window via a heating module to thereby increase temperature along at least some portions of the smart window (e.g. thereby decreasing the temperature gradient); and electrically actuating the smart window to switch from a first transmittance state to a second transmittance state, wherein, via the heating step, the transmittance state from a first transmittance state to a second transmittance state is uniform, when measured via visual observation.

In another aspect, a method is provided, comprising: sensing a plurality of transmittances at a plurality of locations along a smart window; detecting a transmittance gradient above a predetermined threshold; heating at least a portion of the smart window via a heating module to thereby increase temperature along at least some portions of the smart window, thereby decreasing the temperature gradient; and electrically actuating the smart window to switch from a first transmittance state to a second transmittance state, wherein, via the heating step, the transmittance state from a first transmittance state to a second transmittance state is uniform, when measured via visual observation.

In another aspect, a method is provided, comprising: sensing a temperature at a location along a smart window; detecting the temperature is below a predetermined threshold (e.g. operational temperature); heating at least a portion of the smart window via a heating module to thereby raise the temperature to at least the predetermined threshold; and electrically actuating the smart window to switch from a first transmittance state to a second transmittance state, wherein, via the heating step, the transmittance state from a first transmittance state to a second transmittance state is uniform, when measured via visual observation.

In another aspect, a method is provided comprising: sensing a plurality of temperatures across a smart device; averaging the plurality of temperatures to generate an average temperature; comparing the average temperature to a viability threshold temperature and an operational threshold; and generating a response.

In some embodiments, generating a response further comprises: heating continuously via a heating module, when the average temperature is below a viability threshold temperature.

In some embodiments, generating a response further comprises: heating intermittently, when the average temperature is below an operational threshold.

In some embodiments, generating a response further comprises: continuing to monitor by repeating steps (sensing, averaging, comparing, and generating steps), when the average temperature is above each of an operational threshold and a viability threshold.

In another aspect, a method is provided, comprising: providing a smart window having a heating module, wherein the heating module is configured with a plurality of discrete zones, each zone extending along a portion of the smart window, each zone configured with a resistance element (or resistance layer); monitoring an electrical resistance of each corresponding resistance element of each corresponding zone; correlating the plurality of electrical resistances to a plurality of temperatures; (e.g. given voltage, calculate current, understand current over time and corresponding temperature. In some embodiments, the method comprises: increasing current to at least one zone via the heating module. In some embodiments, the method comprises heating at least one zone via the heating module. In some embodiments, the method includes continuing to monitor by repeating steps (monitoring, correlating, increasing current, and heating). In some embodiments, a low current needed on high resistance materials to generate increase in temperature, higher current needed for lower resistance materials to generate temperature); and increasing an electrical current to a zone having a low temperature, when compared to the temperatures for the other zones.

Additional features and advantages will be set forth in the detailed description which follows and will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the disclosure as it is claimed.

The accompanying drawings are included to provide a further understanding of principles of the disclosure, and are incorporated in, and constitute a part of, this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following aspects.

### BRIEF DESCRIPTION OF THE DRAWINGS

These and other features, aspects and advantages of the present disclosure are better understood when the following detailed description of the disclosure is read with reference to the accompanying drawings, in which:

FIG. 1 is a schematic diagram depicting an embodiment of a smart window assembly having an integrated thermal control module, in accordance with one or more embodiments of the present disclosure.

FIG. 2 is a schematic diagram depicting another embodiment of a smart window assembly having an integrated thermal control module comprising a heating module, in accordance with one or more embodiments of the present disclosure.

FIG. 3 is an exploded schematic diagram of an embodiment of a smart window having an integrated thermal control module comprising a heating module, in accordance one or more embodiments of the present disclosure.

FIG. 4A and FIG. 4B depict schematic diagrams of an embodiment of a smart window device having two types of heating modules, a resistance layer and two resistance elements, in accordance with various embodiments of the present disclosure.

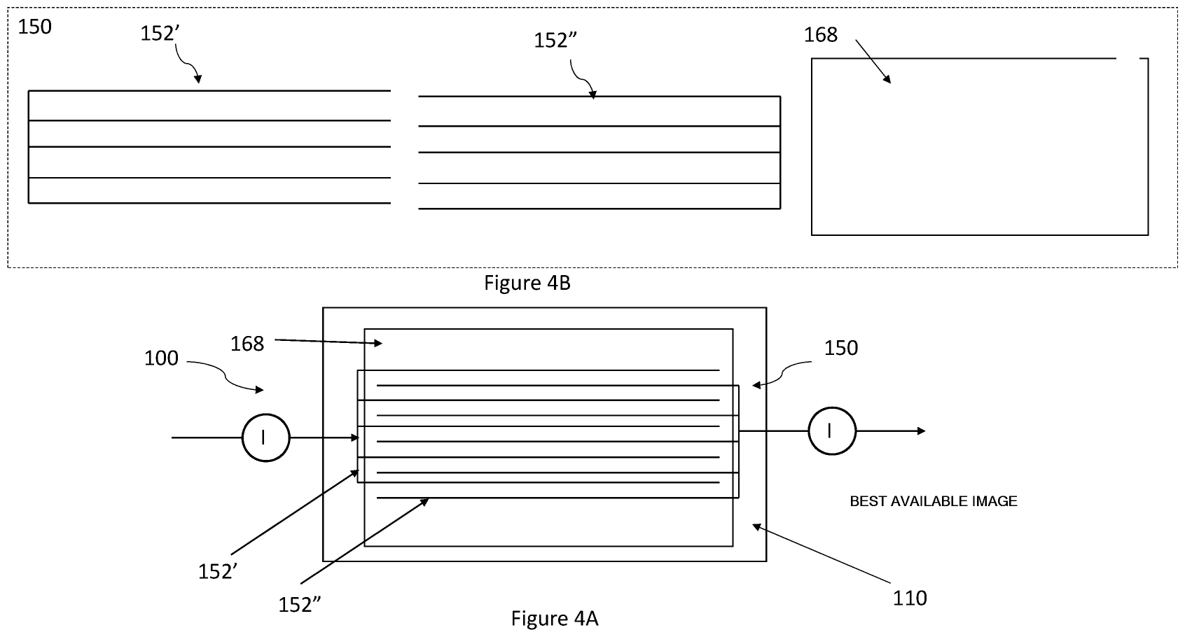

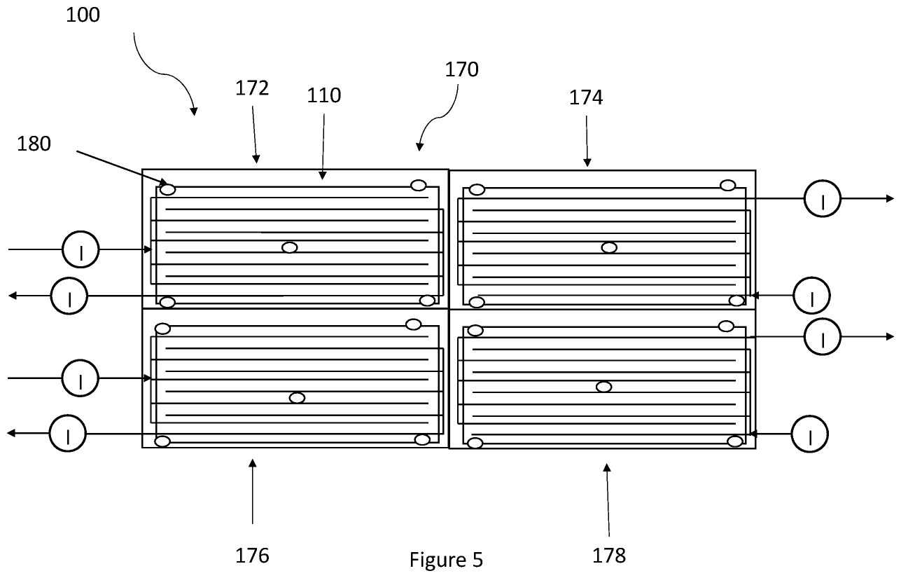

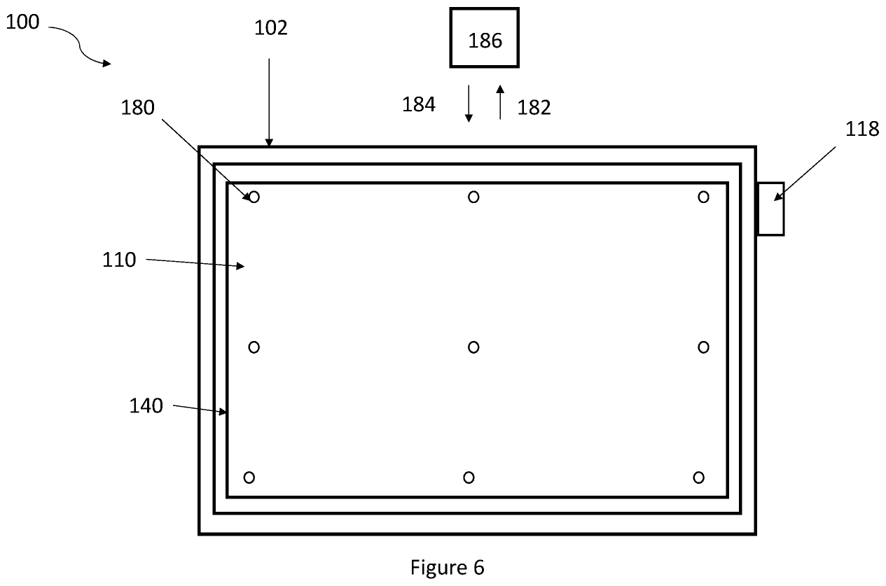

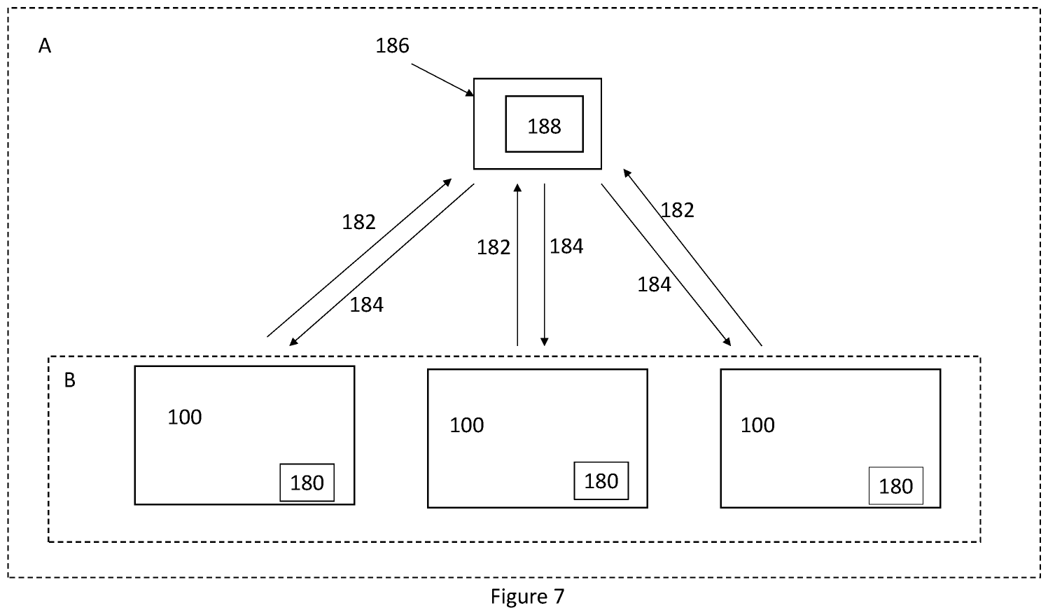

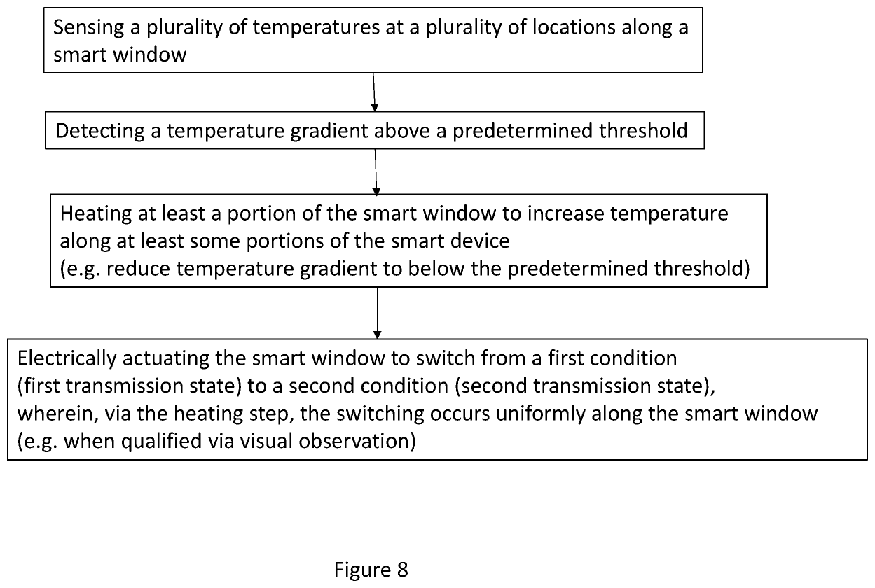

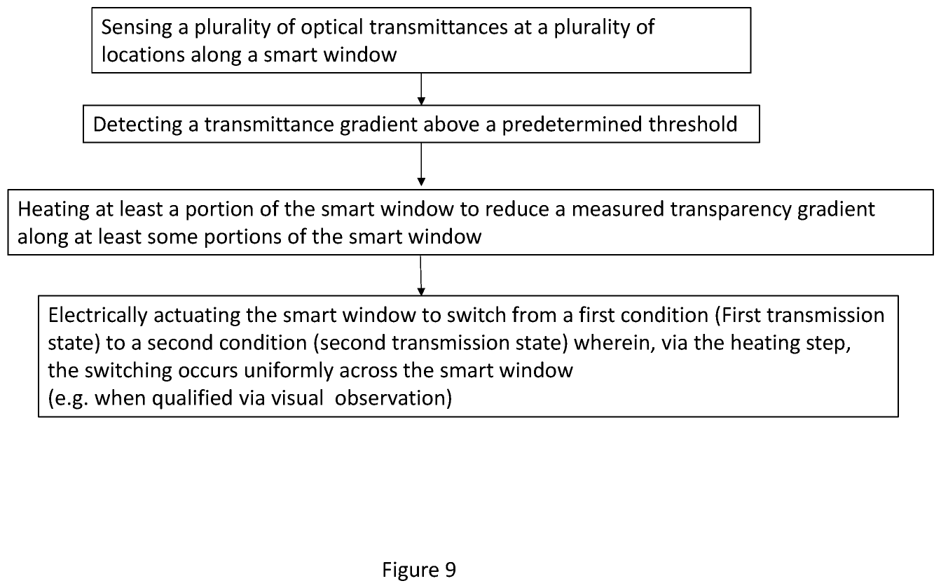

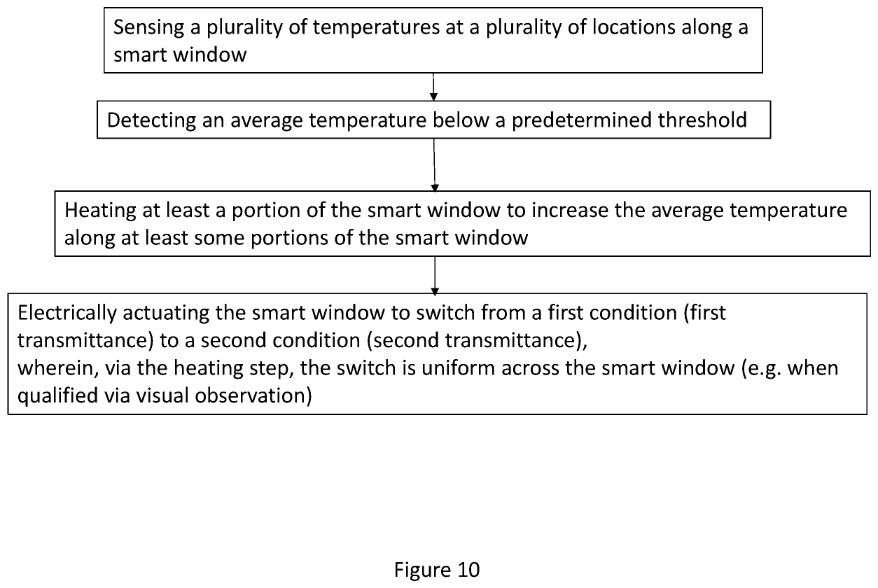

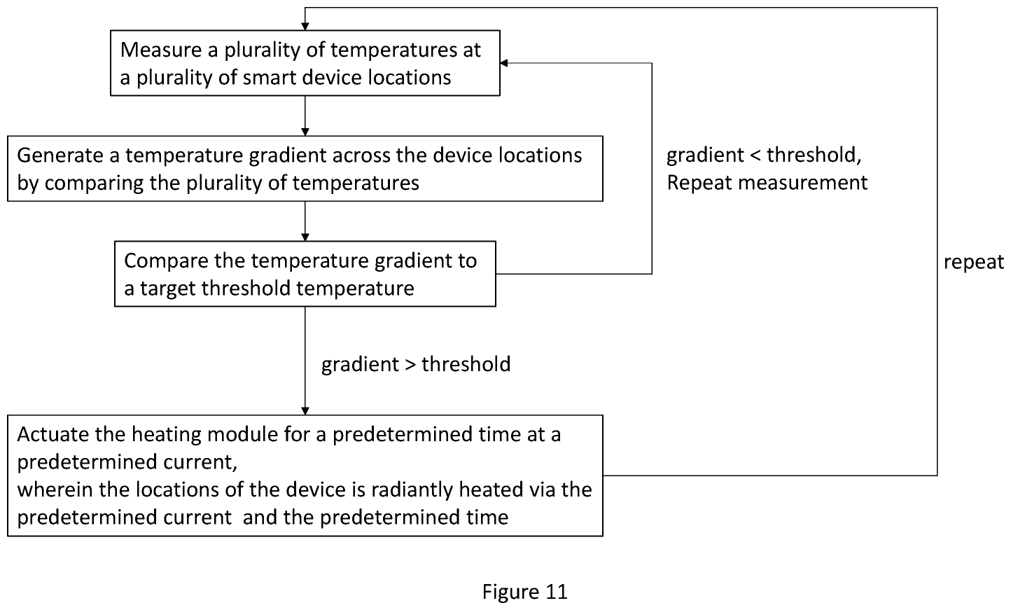

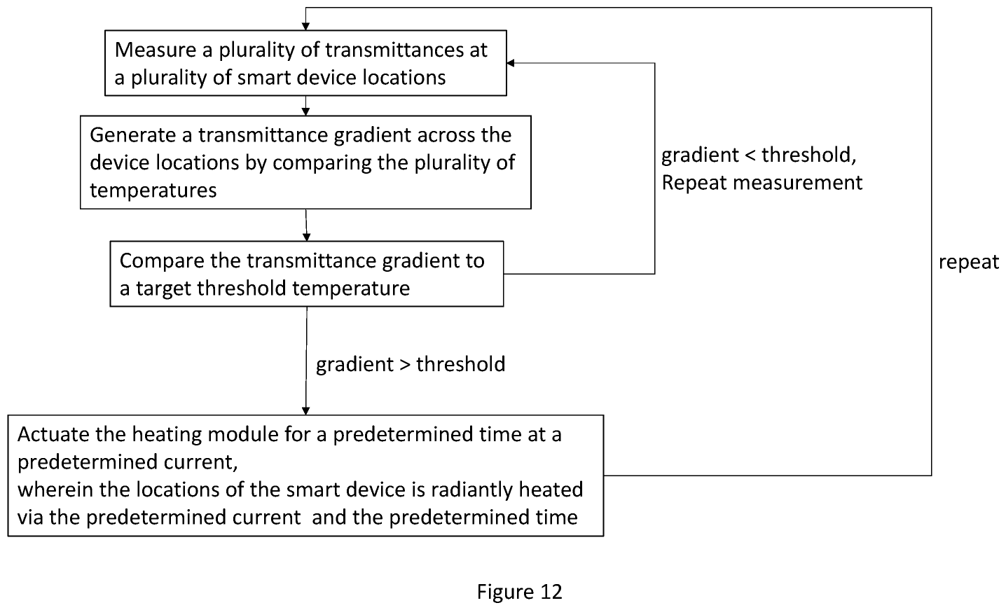

Referring to FIG. 4A, component of the heating members, two heating array embodiments and one heating layer embodiment, are shown in exploded, side-by-side, plan view.

Referring to FIG. 4B, a schematic of the smart window device having the combined (e.g. stacked) heating member is shown relative to the remaining assembly components, in accordance with one or more embodiments of the present disclosure. In this configuration, a plurality of heating members, each having differing areas or portions of the device that they interact with or the same (overlapping) portions of the device, are combinable to provide a tailored heating module (e.g. with localized relatively higher heat in small areas or distributed relatively lower heat in large areas of the device).

FIG. 5 is a schematic of another embodiment of a smart device having discrete zones of heating members (4 shown, 2 upper and 2 lower), in accordance with various embodiments of the present disclosure.

FIG. 6 is a schematic of an embodiment of a sensor array configured to communicate with a control system, utilized in conjunction with the smart device having a heating member, in accordance with various embodiments of the present disclosure.

FIG. 7 depicts and embodiment of a plurality of smart devices having integrated heating modules configured communicate with (direct signals to and receive signals from) a control system having a processor. As shown, the devices and processor can be housed in the same site or the control system can be housed remotely (depicted as ‘in’ or ‘out’ of corresponding optional configurations).

FIG. 8 depicts a method of operating a smart window device having an integrated thermal control module by utilizing temperature-based information, in accordance with various embodiments of the present disclosure.

FIG. 9 depicts a method of operating a smart window device having an integrated thermal control module by utilizing transmittance-based information, in accordance with various embodiments of the present disclosure.

FIG. 10 depicts a method of operating a smart window device having an integrated thermal control module by utilizing temperature-based information, in accordance with various embodiments of the present disclosure.

FIG. 11 depicts a method of operation of a smart window device having an integrated passive thermal control module by utilizing one or more criterion (e.g. temperature or optical transmittance), in accordance with various embodiments of the present disclosure.

FIG. 12 depicts a method of operation of a smart window device having an integrated active thermal control module by utilizing one or more criterion (e.g. temperature or optical transmittance), in accordance with various embodiments of the present disclosure.

### DETAILED DESCRIPTION OF THE DRAWINGS

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

The Figures depict various embodiments for smart window configurations, where embodiments provide: (1) the existing power supply is utilized in both switching mode and heating mode or (2) an additional heating module (including corresponding power supply, resistance element(s) and/or resistance layer(s), and insulating layer are provided).

In some embodiments, the thermal control module is operated during (concomitant with) switching of the smart window. In some embodiments, the thermal control module is operated prior to switching of the smart window. In some embodiments, the thermal control module is operated prior to and in combination with the switching of the smart window (e.g. either as passive/background heating or in instances where temperature gradient(s) and/or temperature thresholds are detected). For example, based on the finite sheet resistance of the electrode (conductive film), by applying electrical current, the electrode is configured to generate resistive heating locally in the smart device. In this configuration, the smart device is heated to provide tailored temperature control in low temperature operating conditions and/or provide a reduced and/or eliminated temperature gradient across the surface of the smart device. Thus, device performance is improved in environmental conditions that would otherwise impact device performance and/or longevity.

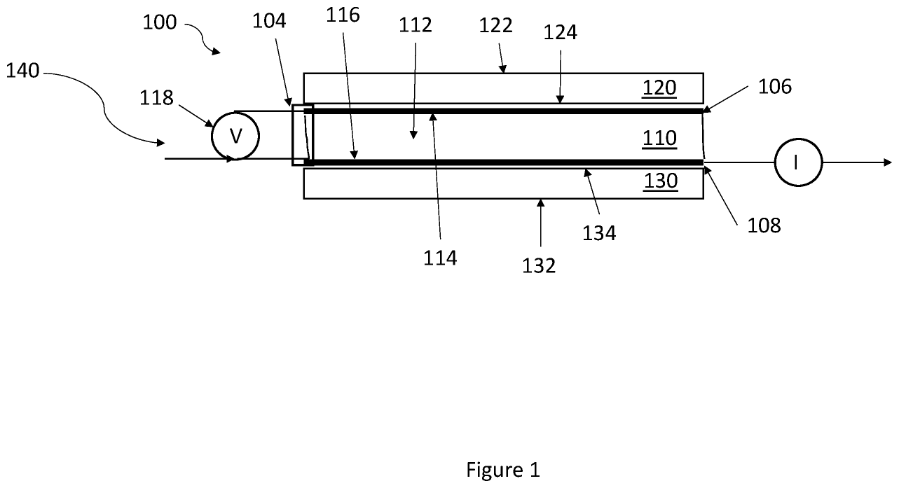

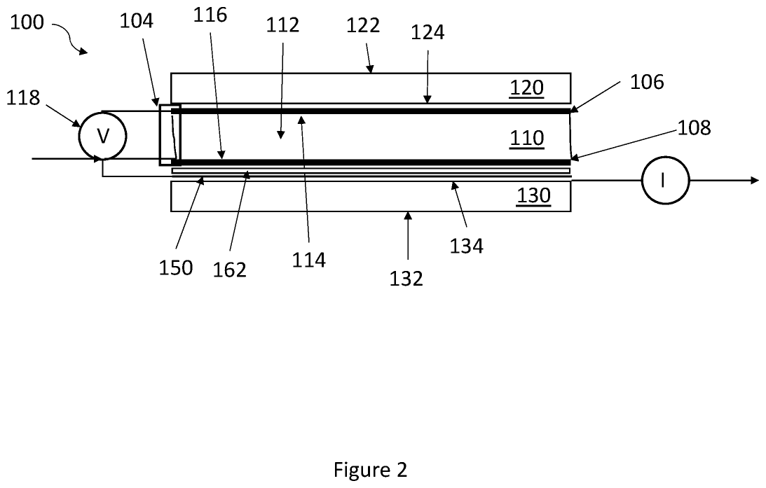

Referring to FIG. 1, a smart window 100 including a smart device 110 configured with an in-situ thermal control module 140 is provided. The smart window 100 includes a smart device 110 positioned between a first layer 120 and a second layer 130. The first layer 120 and second layer 130 are configured with a generally planar configuration and are transparent (e.g. glass or polymer), such that the smart device 110 is visible during operation/in installation. The first layer 120 includes a first layer 120 includes an outer surface 122 and inner surface 124 (adjacent to the first side 114 of smart device 110). The second layer 130 includes an outer surface 132 and an inner surface 134 (adjacent to the second side 116 of smart device 110).

To actuate, the smart device 110 (e.g. electrically switchable material 112) is configured in electrical communication with (via electrical connection 104) a power source 118 (shown with V for providing voltage) via a pair of electrodes, first electrode 106 and second electrode 108 (e.g. anode and cathode). The power source 118 is configured with two modes: in a first mode, the power source 118 supplies a first voltage across the electrodes and corresponding electrically switchable material 112, to actuate a change in the smart window 100 (e.g. establish a voltage drop) such that the transmission state actuates from a first transmission to a second transmission; and in a second mode, the power source 118 is configured to direct current through an electrode (106 or 108), such that the electrical current causes resistive heating in the electrode (and corresponding conductive heat of the smart window 100 components, including the electrically switchable material 112).

Referring to FIG. 1, a smart window 100 including a smart device 110 configured with an in-situ thermal control module 140 is provided. The smart window 100 includes a smart device 110 positioned between a first layer 120 and a second layer 130. The first layer 120 and second layer 130 are configured with a generally planar configuration and are transparent (e.g. glass or polymer), such that the smart device 110 is visible during operation/in installation. The first layer 120 includes a first layer 120 includes an outer surface 122 and inner surface 124 (adjacent to the first side 114 of smart device 110). The second layer 130 includes an outer surface 132 and an inner surface 134 (adjacent to the second side 116 of smart device 110).

To actuate, the smart device 110 (e.g. electrically switchable material 112) is configured in electrical communication with (via electrical connection 104) a power source 118 (shown with V for providing voltage) via a pair of electrodes, first electrode 106 and second electrode 108 (e.g. anode and cathode). Additionally, the power source 118 is configured in electrical communication with (e.g. to supply voltage to) a heating module 150. The heating module 150 is positioned between the second layer 130 and an insulating layer 162 (e.g. dielectric sheet), such that the heating module is electrically isolated from the electrode 108 and configured to provide radiant heat, conductively across the smart window 100 components to direct heat into the electrically conductive material 112 of the smart device 110. Thus, the power supply 118 cooperates the heating module 150 (at least one of: a resistance element and/or resistance layer) to direct current through the heating module 150 to create resistive heating in the electrode (and corresponding conductive heat of the smart window 100 components, including the electrically switchable material 112).

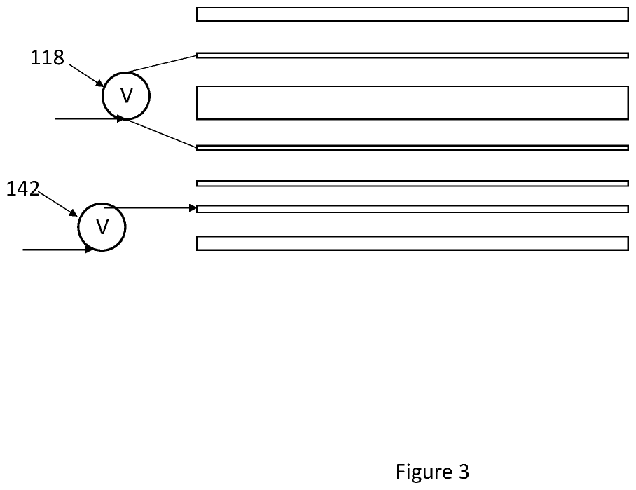

FIG. 3 depicts an exploded schematic view of another embodiment of a smart window 100 having an integrated heating module 150, further providing a second power source 142 configured to direct current to/through the heating module 150 (i.e. the power source 142 is electrically isolated/separate from the smart device 110 power source 118).

FIG. 4 depicts an embodiment of a smart window 100 having a heating module 150 configured from multiple components: two resistance elements 152 (one right-facing 152′ and one left-facing 152″) and one resistance sheet 168. Each of the components is depicted in FIG. 4B, in plan, side-by-side view. FIG. 4A depicts a schematic of the smart window 100, showing the resistance elements 152′ and 152″ in stacked configuration with the resistance layer 168, where the resistance elements are in an interdigitated configuration, to provide tailored delivery of heat (e.g. resistance elements configured with lower resistance so higher current (more heating) and resistance sheet configured with higher resistance, so lower current (less heat).

FIG. 5 depicts another embodiment, showing a smart window 100 having a plurality of zones 170, including four zones, 172, 174, 176, and 178. The smart window 100 is configured with a plurality of sensors 180 across, here, showing 5 sensors interspaced in each zone. The sensors 180 are configured to detect one or more criterion (e.g. temperature, transmission, etc.) and communicate with one or more other smart window 100 and/or control system (not shown) components to provide real-time information on the state of the window.

FIG. 6 depicts a smart window 100 configured with a plurality of sensors 180, where the sensors are configured to communicate with control system 186 to provide sensed criterion to the control system (e.g. temperature, transmittance, or other criterion). Depicted are two arrows: arrow 182, which indicates the detected signals 182 from the sensors 180 and arrow 184, which indicates the control signals 184 directed from the control system to the smart window 100 (e.g. actuating an integrated thermal control module based on the sensed criterion).

FIG. 7 provide a schematic depicting two embodiments of a smart window 100, a embodiment A showing a plurality of smart windows 100 each having an integrated plurality of sensors configured to communicate with an onboard/onsite control system 186 having a processor 188 (e.g. wirelessly or hard wired) and embodiment B, showing a remote configuration of a plurality of smart windows 100 each having an integrated plurality of sensors 180 communicating with a remote control system 186 having an on board processor.

FIG. 8 depicts a flow chart for an embodiment of utilizing the integrated thermal control module of the smart window, showing various steps for a detecting a temperature gradient and heating in response to a temperature gradient below a predetermined threshold.

FIG. 9 depicts a flow chart for an embodiment of utilizing the integrated thermal control module of the smart window, showing various steps for a detecting a transmittance gradient and heating in response to a transmittance gradient below a predetermined threshold.

FIG. 9 depicts a flow chart for an embodiment of utilizing the integrated thermal control module of the smart window, showing various steps for a detecting an average temperature and heating in response to a average temperature below a predetermined threshold.

FIG. 11 depicts a flow chart of the steps of a method of detecting and actuating the integrated heating module in conjunction with temperature feedback, depicting a continuous monitoring and feedback loop.

FIG. 12 depicts a flow chart of the steps of a method of detecting and actuating the integrated heating module in conjunction with transmittance feedback, depicting a continuous monitoring and feedback loop.

Many variations and modifications may be made to the above-described embodiments of the disclosure without departing substantially from the spirit and various principles of the disclosure. All such modifications and variations are intended to be included herein within the scope of this disclosure and protected by the following claims.

### REFERENCE NUMBERS

Smart window assembly 100

Frame 102

Sealing member 104

Smart device (e.g. panel) 110

Electrically switchable material 112

First sidewall (of smart device) 114

Second sidewall (of smart device) 116

Electrical connection 104

Power source 118 (e.g. configured to direct either switching current or heating current to electrode(s) of smart device)

First electrode 106

Second electrode 108

Integrated thermal control module 140

Power source (of heating module) 142

Electrical bus work/connections 144

First pane 120 (e.g. transparent, optically clear, glass, glass laminate, or polymer)

Outer surface first pane 122

Inner surface first pane 124

Second pane 130 (e.g. transparent, optically clear, glass, glass laminate, or polymer)

Outer surface second pane 132

Inner surface second pane 134

Heating module 150 (e.g. resistance layer (transparent) or resistance element (transparent or non-transparent))

Resistance element 152 (e.g. configured in pattern, lines, mesh, grid, geometric, concentric, etc.)

Insulating layer 162 (e.g. dielectric layer, portion, sheet, film, coating)

Resistance layer 168 (e.g. layer, sheet, film, coating)

Plurality of zones 170

Zone 1 172

Zone 2 174

Zone 3 176

Zone 4 176

Plurality of sensors 180

Detect signal 182

Control signal 184

Control System 186

Processor 188

1) An apparatus, comprising:
a. a smart device comprising:
i. a first layer;
ii. a second layer,
iii. an electrically switchable material configured between the first layer and the second layer, wherein the electrically switchable material is configured to provide a transparent mode and a non-transparent mode,
iv. a pair of electrodes, including an anode and a cathode, wherein each of the electrodes is configured in electrical communication with the electrically switchable material; and
v. a power source configured in electrical communication with the electrodes, further wherein the power source is configured to provide:
(1) a switching mode current to the electrically switchable material and
(2) a heating mode current via at least one electrode.

2) The apparatus of claim 1, wherein an electrode is configured as an ohmic heater.

3) The apparatus of claim 1, further, comprising:
b. an integrated heating module configured between the electrically switchable material and one of: the first layer and the second layer,
wherein the integrated heating module is configured to provide resistant heating along at least a portion of the electrically switchable material.

4) The apparatus of claim 1, wherein the smart device comprises a smart window.

5) The apparatus of claim 1, wherein the smart window is greater than 10″×10″.

6) The apparatus of claim 4, wherein the smart window is selected from the group consisting of: a liquid crystal window; a photochromic window, a micro-blinds window, and suspended particles window.

7) The apparatus of claim 6, wherein the smart window comprises a liquid crystal, electrically switchable material comprises at least one liquid crystal.

8) The apparatus of claim 7, wherein the smart window is a single pixel cell liquid crystal window.

9) The apparatus of claim 6, wherein the smart window comprises a photochromic window, the electrically switchable material comprises a nano-crystalline film.

10) The apparatus of claim 6, wherein the smart window comprises a micro-blinds window, the electrically switchable material comprises a plurality of conductive metal oxide members.

11) The apparatus of claim 6, wherein the smart window comprises a suspended particle window, the electrically switchable material comprises a plurality of rod-shaped, electrically alignable particles.

12) The apparatus of claim 3, wherein the heating module comprises:
a. an electrically insulating sheet configured to promote electrical separation from the electrically switchable material and the heating module; and
b. a power supply configured to provide current to the heating module, wherein the power supply is configured electrically isolated from the electrically switchable material.

13) The apparatus of claim 12, wherein the heating module comprises a resistance layer.

14) The apparatus of claim 12, wherein the resistance layer is selected from: a transparent conductive layer.

15) The apparatus of claim 12, wherein the resistance layer is configured as a sheet, a coating, a film, and/or combinations thereof.

16) The apparatus of claim 12, wherein the heating module comprises a resistance element.

17) The apparatus of claim 12, wherein the resistance element is selected from: a transparent conductive layer, a semi-transparent conductive layer, a non-transparent conductive layer, and combinations thereof.

18) The apparatus of claim 12, wherein the resistance element is configured with a tailored pattern.

19) The apparatus of claim 18, wherein the tailored pattern is selected from the group consisting of: a grid, a ribbon, a wire, a mesh, a geometric shape, a plurality of concentric shapes, and/or combinations thereof.

20) The apparatus of claim 12, wherein the heating module comprises: a resistance layer and a resistance element.

21)-40). (canceled)
